(19) United States
(12) Patent Application Publication
(10) Pub. No.: US 2010/0217551 A1
(43) Pub. Date: Aug. 26, 2010

(54) Embedded microprocessor system for vehicular batteries

(76) Inventors: Lonnie Calvin Goff, Tempe, AZ (US); Mark E. Eidson, Tempe, AZ (US); Michael Richard Conley, Thousand Oaks, CA (US)

Correspondence Address: Lonnie Goff, 1433 S. Mill Ave, Tempe, AZ, 85281, US

(21) Appl. No.: 12/380,236

(22) Filed: Feb. 25, 2009

(51) Int. Cl. G06F 19/00; G06F 15/00

(52) U.S. Cl. 702/63; 702/188

(57) ABSTRACT

A computer system embedded inside a starter or deep cycle battery that includes manufacturing data, the means to monitor battery pressure, the means to monitor electrolyte level and the means to transfer information to an external device.

### CROSS REFERENCE TO RELATED APPLICATIONS

This application is related to the following applications that have all been filed by the present inventors. Ser. No. 12/075,212 filed on Mar. 10, 2008 and entitled “Battery Monitor System Attached to a Vehicle Wiring Harness”. Ser. No. 12/070,793 filed on Feb. 20, 2008 and entitled “Multi-function Battery Monitor System for Vehicles”. Ser. No. 12/319,544 filed on Jan. 8, 2009 and entitled “Battery Monitoring Algorithms for Vehicles”. And Ser. No. 12/321,310 filed on Jan. 15, 2009 and entitled “Embedded Monitoring System for Batteries”.

### FEDERALLY SPONSORED RESEARCH OR DEVELOPMENT

Not Applicable

### SEQUENCE LISTING, TABLE OR COMPUTER PROGRAM LISTING ON CD

Not Applicable

### BACKGROUND OF THE INVENTION

1. Field of Invention

The present invention relates to the field of computers. In particular it relates to computer based methods for measuring and making available important internal information in both vehicular and deep cycle power batteries.

2. Prior Art

All batteries fail. The life expectancy of an automobile battery ranges from 30 months in southern Arizona to 51 months in Alaska. In 2006, the number of replacement batteries sold in the US was approximately 75 million units. This represents an annual replacement cost to the American consumer of over 4 billion dollars. In addition to the upfront consumer cost associated with battery replacement there is both an energy and an environmental cost associated with the recycling of dead batteries. There is a cost in non-renewable fossil fuel to transport millions of batteries to recycle centers. There is an additional energy cost required to pulverize battery cases and finally there is a very large energy cost associated with smelting the lead and various other separated materials. Lastly, assuming 98% of all batteries get recycled, there still remains over 1 million units full of toxic lead and caustic acid that are dumped in the environment every year.

The single most prevalent cause of premature deep cycle and starting battery failures is incorrect battery charging. Overcharging causes grid corrosion. Undercharging causes battery sulfation. Both lead to premature battery failure.

Charging systems included in today's automobiles are blind devices. In order for the correct charge to be applied to any battery, the internal temperature and pressure must be known. Also different battery types require different charging voltages. An Absorbed Glass Mat battery should be charged at 14.3 volts when the temperature of the battery is 80 degrees Fahrenheit. A flooded Maintenance Free battery should be charged at 14.8 volts for the same temperature. The construction type of the installed battery must therefore be made known to the charging system. Finally, the level of the battery's electrolyte must be made available to both the charging system and the vehicle's operator so that appropriate action can be taken when the level is low.

None of today's vehicular batteries provide the information required by charging systems to perform optimal charging. Optimal charging which will in turn eliminate the most prevalent of premature battery failures as well as enhance the normal life expectancy of all vehicular batteries.

### BRIEF SUMMARY OF THE INVENTION

The present invention makes use of a computer system that is designed to reside inside the case of a vehicular or deep cycle battery. The computer system can either make use of one or more of the battery's cells as its power source or include provisions for a separate power source. The computer system may include one or more liquid level sensors and one or more pressure sensors. The computer system includes a means for measuring time, a data storage facility for retaining a history of measurements, information that specifies the temperature dependent optimum charging voltage of the battery, manufacturing information relating to the battery type, serial number, and date of manufacture. The computer system also includes an electrical interface that can transfer information to locations external to the battery.

Per one embodiment, the computer system includes a pressure sensor, a liquid level sensor and manufacturing information. The manufacturing information and the information read from these sensors is transferred over the battery's power cable by using an automotive industry standard protocol such as the LIN-Bus (Local Interconnect Network).

Per another embodiment, the computer system includes liquid level sensors installed in each battery cell and manufacturing information. The manufacturing information and the information read from these sensors is transferred over a wired bus using an automotive industry standard protocol such as the CAN-Bus (Controller Area Network).

Per yet another embodiment, the computer system includes a pressure sensor and manufacturing information. This information is transferred using a wireless based protocol such as IEEE 802.15.4.

### BRIEF DESCRIPTION OF THE DRAWINGS

FIG. 1 is a block diagram of a computer based system shown embedded inside an automotive battery. This system includes means for measuring internal pressure and the level of the electrolyte. The computer system includes information stored in a non-volatile memory system relating to the manufacture and charging characteristics of the battery. The computer system also includes means for transmitting and receiving data across the power cable that is attached to the battery terminal.

FIG. 1A is a flow chart illustrating the steps taken by the computer system of FIG. 1 to make available battery manufacturing information, the electrolyte level and the internal pressure of the battery to an external device.

FIG. 2 is a block diagram of a computer based system shown embedded inside an automotive battery. This system includes means for measuring internal pressure as well as the level of the electrolyte for each individual cell. The computer system includes information stored in a non-volatile memory system relating to the manufacture and charging characteristics of the battery. The computer system also includes means for transmitting and receiving data across a wired communication channel.

FIG. 2A is a flow chart illustrating the steps taken by the computer system of FIG. 2 to make available battery manufacturing information, the electrolyte level of each cell and the internal pressure of the battery to an external device.

FIG. 3 is a block diagram of a computer based system shown embedded inside an automotive battery. This system includes the means for measuring the internal pressure of the battery. The computer system includes information stored in a non-volatile memory system relating to the manufacture and charging characteristics of the battery. The computer system also includes means for transmitting and receiving data across a wireless communication medium.

FIG. 3A is a flow chart illustrating the steps taken by the computer system of FIG. 3 to make available battery manufacturing information and the internal pressure of the battery to an external device.

### DETAILED DESCRIPTION OF THE INVENTION

The following descriptions are provided to enable any person skilled in the art to make and use the invention and is provided in the context of three particular embodiments. Various modifications to these embodiments are possible and the generic principles defined herein may be applied to this and other embodiments without departing from the spirit and scope of the invention. Thus the invention is not intended to be limited to the embodiments shown but is to be accorded the widest scope consistent with the principles, features and teachings disclosed herein.

In accordance with one embodiment, the present invention makes use of a computer system that resides inside a battery's case and communicates to the outside world through the power cable attached to the battery's power terminal. The computer system includes pressure and liquid level sensors. The computer system's central processing unit also has the ability to measure time and includes facilities for storing data. The computer system's non-volatile memory includes manufacturing information as it relates to the battery's construction, optimal charging characteristics, date of manufacture and serial number.

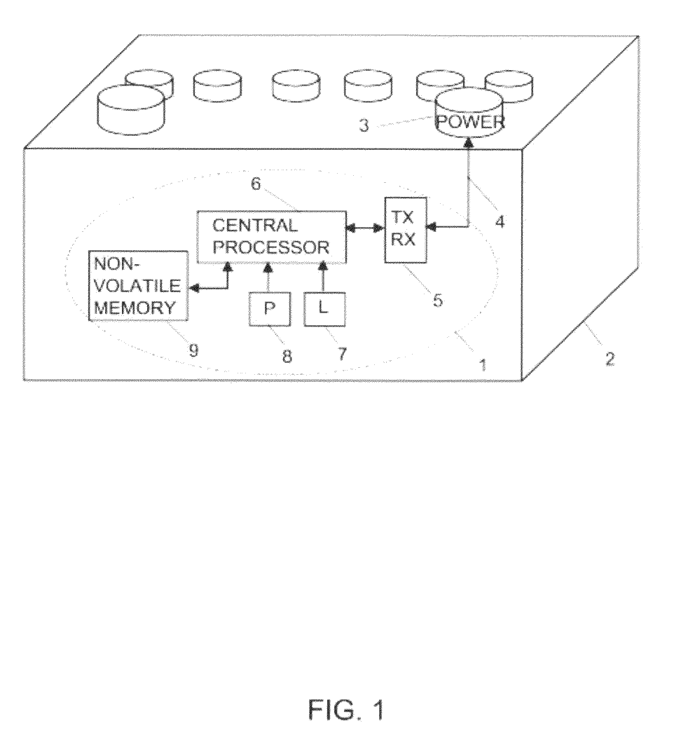

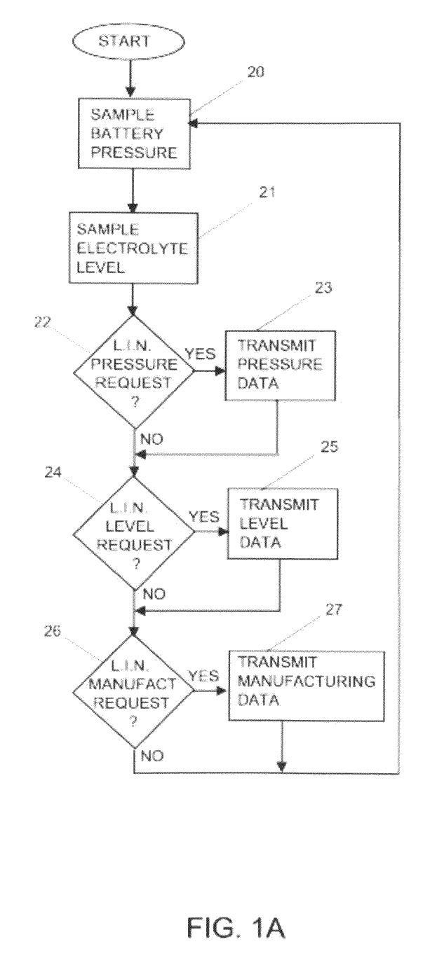

FIG. 1 is a block diagram illustrating computer system 1 shown embedded inside battery 2. Computer system 1 includes an electrical connection to battery terminal 3 through conductor 4. Transceiver 5 is used to receive and transmit data between central processor 6 and one or more external devices (not shown) attached to the terminal 3 power cable using the industry standard Local Interconnect Network vehicle bus protocol. Level sensor 7 measures the level of the electrolyte for a specific battery cell. This information is retrieved and saved by central processor 6. Pressure sensor 8 measures the internal pressure inside the battery's case. This information is retrieved and saved by central processor 6. Central processor 6 includes in its non-volatile memory 9 manufacturing information. Central processor 6 uses transceiver 5 to monitor data activity which may be present on power terminal 3.

FIG. 1A is a flowchart illustrating those steps taken by computer system 1 in FIG. 1 in order to gather information about the internal state of the battery and to make this information available to an external device (not shown). In step 20 of FIG. 1A the battery pressure sensor 8 of FIG. 1 is sampled by central processor 6 of FIG. 1 and saved. At step 21 of FIG. 1A level sensor 7 in FIG. 1 is sampled by central processor 6 in FIG. 1 and saved. At step 22 a Local Interconnect Network protocol check is made using transceiver 5 in FIG. 1 by central processor 6 in FIG. 1 to see if an external device (not shown) is requesting pressure data. If no request is pending, program control proceeds to step 24. If a pressure reading is requested, program control proceeds to step 23 where the requested data is transferred using transceiver circuit 5 in FIG. 1 by central processor 6 in FIG. 1. The data passes to terminal 3 in FIG. 1 using conductor 4 in FIG. 1. Data then travels across the power cable (not shown) attached to connector 3 in FIG. 1 to the requesting device (not shown). Program control then proceeds to step 24. At step 24 a Local Interconnect Network protocol check is made using transceiver 5 in FIG. 1 by central processor 6 in FIG. 1 to see if an external device (not shown) is requesting electrolyte level data. If no request is pending, program control proceeds to step 26. If a level reading is requested, program control proceeds to step 25 where the requested data is transferred using transceiver circuit 5 in FIG. 1 by central processor 6 in FIG. 1. Program control then proceeds to step 26. At step 26 a Local Interconnect Network protocol check is made using transceiver 5 in FIG. 1 by central processor 6 in FIG. 1 to see if an external device (not shown) is requesting manufacturing data. If no request is pending, program control proceeds to step 20. If manufacturing data is requested, program control proceeds to step 27 where the requested data is transferred using transceiver circuit 5 in FIG. 1 by central processor 6 in FIG. 1. Program control then proceeds to step 20. The flowchart repeats.

In accordance with another embodiment, the present invention makes use of a computer system that resides inside a battery's case and communicates to the outside world through a communication connector installed in the battery's case. The computer system includes one pressure sensor and one liquid level sensor installed in each battery cell. The computer system's central processing unit also has the ability to measure time and includes facilities for storing data. The computer system's non-volatile memory includes manufacturing information as it relates to the battery's construction, optimal charging characteristics, date of manufacture and serial number.

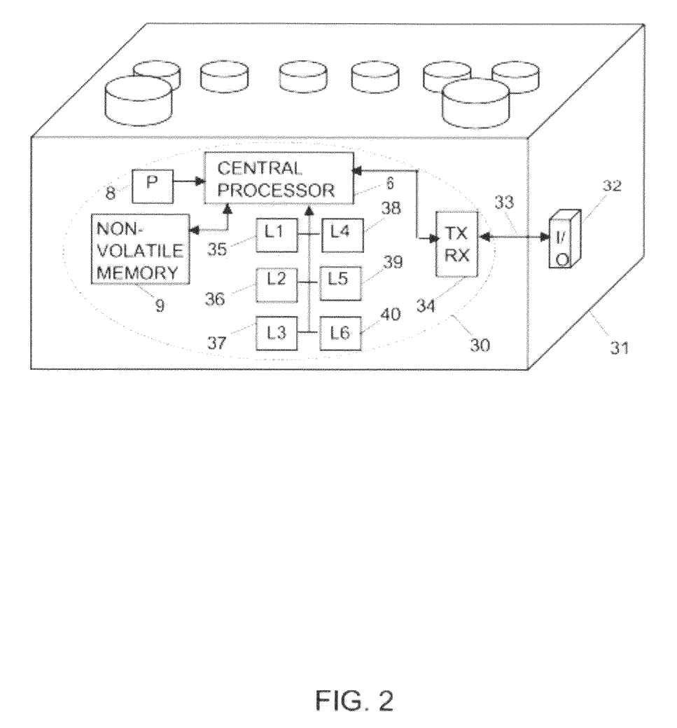

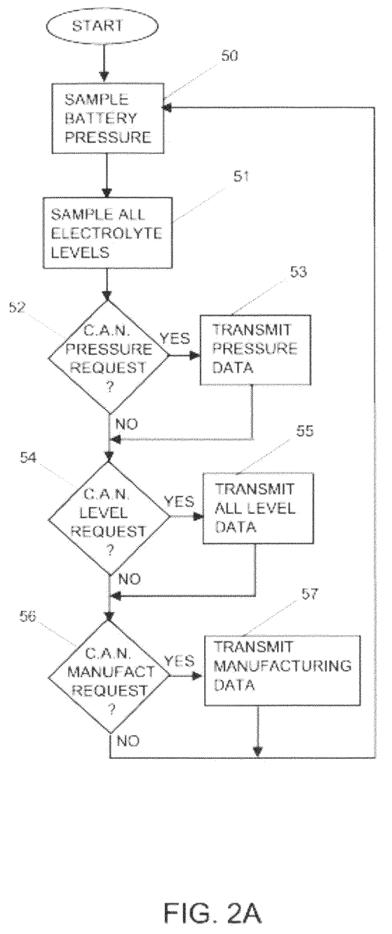

FIG. 2 is a block diagram illustrating computer system 30 shown embedded inside battery 31. Computer system 30 includes a data path to communication connector 32 through conductor 33. Transceiver 34 is used to receive and transmit data between central processor 6 and one or more external devices (not shown) attached to connector 32 using the industry standard Controller Area Network vehicle bus protocol. Pressure sensor 8 measures the internal pressure inside the battery's case. Level sensors 35-40 measure the level of the electrolyte for individual battery cells. Central processor 6 includes in its non-volatile memory 9 manufacturing information. Central processor 6 uses transceiver 34 to monitor data activity which may be present on communication connector 32.

FIG. 2A is a flowchart illustrating those steps taken by computer system 30 in FIG. 2 in order to gather information about the internal state of the battery and to make this information available to an external device (not shown). In step 50 of FIG. 2A the battery pressure sensor 8 of FIG. 2 is sampled by central processor 6 of FIG. 2 and saved. At step 51 of FIG. 2A level sensors 35-40 in FIG. 2 are all sampled by central processor 6 in FIG. 2 and saved. At step 52 a Controller Area Network protocol check is made using transceiver 34 in FIG. 2 by central processor 6 in FIG. 2 to see if an external device (not shown) is requesting pressure data. If no request is pending, program control proceeds to step 54. If a pressure reading is requested, program control proceeds to step 53 where the requested data is transferred using transceiver circuit 34 in FIG. 2 by central processor 6 in FIG. 2. The data passes to communication connector 32 in FIG. 2 using conductor 33 in FIG. 2. Data then travels across the communication cable (not shown) attached to connector 32 in FIG. 2 to the requesting device (not shown). Program control then proceeds to step 54. At step 54 a Controller Area Network protocol check is made using transceiver 34 in FIG. 2 by central processor 6 in FIG. 2 to see if an external device (not shown) is requesting electrolyte level data. If no request is pending, program control proceeds to step 56. If level readings are requested, program control proceeds to step 55 where the requested data is transferred using transceiver circuit 34 in FIG. 2 by central processor 6 in FIG. 2. Program control then proceeds to step 56. At step 56 a Controller Area Network protocol check is made using transceiver 34 in FIG. 2 by central processor 6 in FIG. 2 to see if an external device (not shown) is requesting manufacturing data. If no request is pending, program control proceeds to step 50. If manufacturing data is requested, program control proceeds to step 57 where the requested data is transferred using transceiver circuit 34 in FIG. 2 by central processor 6 in FIG. 2. Program control then proceeds to step 50. The flowchart repeats.

In accordance with still yet another embodiment, the present invention makes use of a computer system that resides inside a battery's case and communicates to the outside world through an antenna installed in the battery's case. The computer system includes a pressure sensor. The computer system's central processing unit also has the ability to measure time and includes facilities for storing data. The computer system's non-volatile memory includes manufacturing information as it relates to the battery's construction, optimal charging characteristics, date of manufacture and serial number.

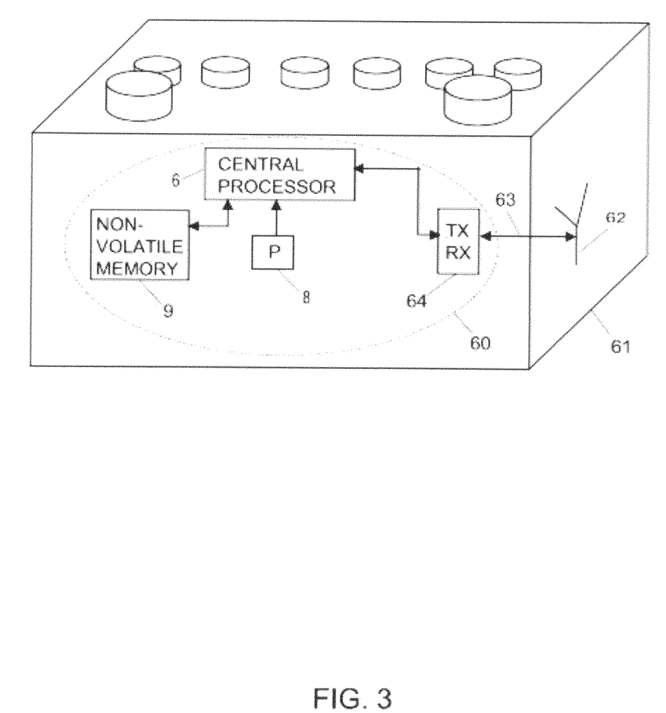

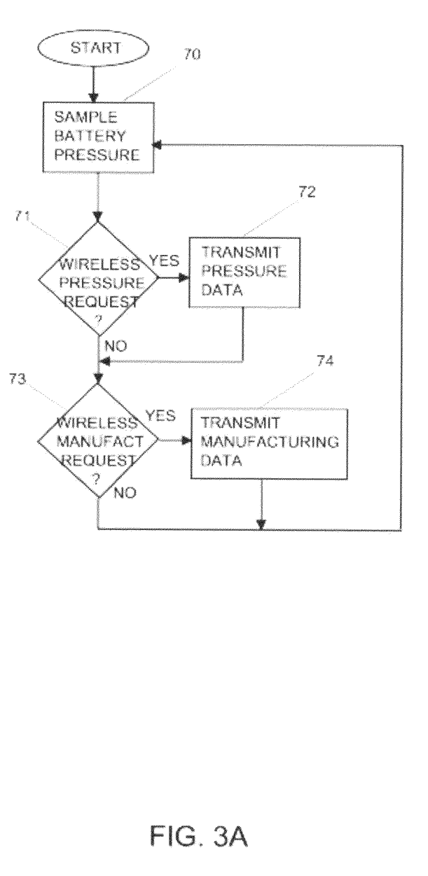

FIG. 3 is a block diagram illustrating computer system 60 shown embedded inside battery 61. Computer system 60 includes a data path to antenna 62 through conductor 63. Transceiver 64 is used to receive and transmit data between central processor 6 and one or more external devices (not shown) using the industry standard IEEE 802.15.4 low-rate Wireless Personal Area Network protocol. Pressure sensor 8 measures the internal pressure inside the battery's case. Central processor 6 includes in its non-volatile memory 9 manufacturing information. Central processor 6 uses transceiver 64 to monitor data activity which may be present on antenna 62.

FIG. 3A is a flowchart illustrating those steps taken by computer system 60 in FIG. 3 in order to gather information about the internal state of the battery and to make this information available to an external device (not shown). In step 70 of FIG. 3A the battery pressure sensor 8 of FIG. 3 is sampled by central processor 6 of FIG. 3 and saved. At step 71 a Wireless Personal Area Network protocol check is made using transceiver 64 in FIG. 3 by central processor 6 in FIG. 3 to see if an external device (not shown) is requesting pressure data. If no request is pending, program control proceeds to step 73. If a pressure reading is requested, program control proceeds to step 72 where the requested data is transferred using transceiver circuit 64 in FIG. 3 by central processor 6 in FIG. 3. The data passes to antenna 62 in FIG. 3 using conductor 63 in FIG. 3. Data then travels through the wireless medium to the requesting device (not shown). Program control then proceeds to step 73. At step 73 a Wireless Personal Area Network protocol check is made using transceiver 64 in FIG. 3 by central processor 6 in FIG. 3 to see if an external device (not shown) is requesting manufacturing data. If no request is pending, program control proceeds to step 70. If manufacturing data is requested, program control proceeds to step 74 where the requested data is transferred using transceiver circuit 64 in FIG. 3 by central processor 6 in FIG. 3. Program control then proceeds to step 70. The flowchart repeats.

### Advantage

The distinct advantage of this invention is that intelligent charging systems can now be implemented that will eliminate most premature battery failures and will extend expected battery life by utilizing the information contained within the battery in order to apply optimal charging routines. Various embodiments of this invention require little or no modification to the battery's case.

The present inventors are cognizant of the harsh environment inside vehicular and deep cycle batteries. Typically these batteries contain liquid sulfuric acid which can readily destroy electrical circuits. It is understood that the embedded computer system of this invention must be encased in a material that is impervious to battery acid. Polymers such as polypropylene or polyethylene are examples of viable solutions.

What is claimed is:

1. A computer system device embedded inside a vehicular battery that includes the means for storing manufacturing information, the means for measuring the internal state of the battery and the means for transferring information outside the battery.

2. The computer system device of claim 1 wherein said means to transfer information outside the battery makes use of the battery's power cable as the communication medium.

3. The computer system device of claim 1 wherein said means to transfer information outside the battery makes use of a communication connector installed in the battery's case and makes use of a wired medium installed in the communication connector.

4. The computer system device of claim 1 wherein said means to transfer information outside the battery makes use of an antenna installed in the battery's case.

5. The computer system device of claim 2 wherein said means for measuring the internal state of the battery includes the means for measuring internal pressure.

6. The computer system device of claim 2 wherein said means for measuring the internal state of the battery includes the means for measuring the level of the electrolyte.

7. The computer system device of claim 2 wherein said manufacturing information includes the type of battery construction.

8. The computer system device of claim 2 wherein said manufacturing information includes the optimal temperature dependent battery charging voltage.

9. The computer system device of claim 3 wherein said means for measuring the internal state of the battery includes the means for measuring internal pressure.

10. The computer system device of claim 3 wherein said means for measuring the internal state of the battery includes the means for measuring the level of the electrolyte.

11. The computer system device of claim 3 wherein said manufacturing information includes the type of battery construction.

12. The computer system device of claim 3 wherein said manufacturing information includes the optimal temperature dependent battery charging voltage.

13. The computer system device of claim 4 wherein said means for measuring the internal state of the battery includes the means for measuring internal pressure.

14. The computer system device of claim 4 wherein said means for measuring the internal state of the battery includes the means for measuring the level of the electrolyte.

15. The computer system device of claim 4 wherein said manufacturing information includes the type of battery construction.

16. The computer system device of claim 4 wherein said manufacturing information includes the optimal temperature dependent battery charging voltage.
